(19) United States
(12) Patent Application Publication
(10) Pub. No.: US 2018/0285904 A1
(43) Pub. Date: Oct. 4, 2018

(54) FAST AND SCALABLE CROWD CONSENSUS TOOL

(71) Applicant: CA, INC., New York, NY (US)

(72) Inventors: MARC SOLE SIMO, BARCELONA (ES); VICTOR MUNTES MULERO, BARCELONA (ES); JACEK DOMINIAK, ELBLAG (PL)

(21) Appl. No.: 15/485,728

(22) Filed: Apr. 12, 2017

(30) Foreign Application Priority Data
Mar. 30, 2017 (ES) P 201700339

(51) Int. Cl. G06Q 30/02; G06F 17/30; G06N 5/04; G06N 99/00

(52) U.S. Cl. CPC G06Q 30/0203; G06N 99/005; G06N 5/04; G06F 17/30684

(57) ABSTRACT

Systems and methods are provided for aiding participants in meaningfully contributing to event online Q&A with minimal loss of attention to the event. As a user is inputting an event contribution fragment, probable event contribution completions are predicted. Based on the predicted event contribution completions, semantically-similar, prior-received event contributions are presented to the user. The user is permitted to act upon the similar contributions in lieu of completing and/or publishing his or her own contribution. For instance, the user may be provided the ability to vote on, comment on, or amend the semantically-similar, prior-received event contribution in lieu of completing and/or publishing his or her own contribution. Upon receiving an indication of a desired user action with respect to a semantically-similar, prior-received event contribution, the user-input event contribution fragment is discarded and the user's action on the prior-received event contribution is published in lieu thereof.

### RELATED APPLICATION

This application claims priority to Spanish Application No. P 201700339, filed Mar. 30, 2017.

### BACKGROUND

Large events (e.g., lectures, conferences, and the like) are increasingly using interactive online question and answer (Q&A) tools to offer real-time feedback. For instance, there are a number of mobile, real-time Q&A tools in the marketplace that enable participants to respond to content, ask questions, answer questions, or otherwise provide comments during an event, for instance, utilizing their mobile devices on mobile browsers. While offering much useful feedback, there can be instances in which the number of questions or other contributions becomes so numerous that either the number of duplicate and/or highly-related contributions increases because a participant cannot keep up with them all, thus decreasing the overall quality of the contributions, or participants begin to miss content associated with the actual event because they are distracted by viewing and/or addressing the contributions provided by other participants and/or event coordinators.

### SUMMARY

This Summary is provided to introduce a selection of concepts in a simplified form that are further described below in the Detailed Description. This Summary is not intended to identify key features or essential features of the claimed subject matter, nor should it be used as an aid in determining the scope of the claimed subject matter.

Embodiments of the present disclosure relate to systems and methods that aid users participating in events employing interactive online Q&A tools in meaningfully contributing to the Q&A with minimal loss of attention to the event. In this regard, embodiments of the present disclosure provide systems and methods that present to a user, while the user is inputting an event contribution, similar event contributions (e.g., provided by other event participants) and permit the user to act upon the similar in lieu of completing and/or publishing his or her own contribution. Input of an event contribution fragment is detected. While the event contribution fragment is being input (e.g., while the user is typing his or her event contribution but prior to completion thereof), a probable event contribution completion for the user's event contribution fragment is predicted. Based upon the predicted event contribution completion, at least one semantically-similar, prior-received event contribution is provided to the user. Also provided is the ability for the user to act upon the prior-received contribution in lieu of completing and/or publishing his or her own event contribution. For instance, the user may be provided the ability to vote on, comment on, or amend the semantically-similar, prior-received event contribution in lieu of completing and/or publishing his or her own contribution. Upon receiving an indication of a desired user action with respect to the semantically-similar, prior-received event contribution, the user-input event contribution fragment is discarded and the user's action on the prior-received event contribution is published in lieu thereof.

### BRIEF DESCRIPTION OF THE DRAWINGS

The present invention is described in detail below with reference to the attached drawing figures, wherein:

FIG. 1 is a schematic diagram showing an exemplary crowd consensus user interface for a mobile device, the exemplary user interface configured to present semantically-similar, prior-received event contributions and permit user action with respect to such contributions, in accordance with an embodiment of the present disclosure;

FIG. 2 is a block diagram showing an exemplary system for predicting event contribution completions from event contribution fragments, presenting prior-received event contributions that are semantically similar to predicted event contribution completions, and permitting a user to act upon prior-received, semantically-similar event contributions in lieu of completing and/or publishing his or her own contributions, in accordance with an embodiment of the present disclosure;

FIG. 3 is a schematic diagram showing an exemplary hierarchical Markov Chain that may be used in predicting event contribution completions, in accordance with an embodiment of the present disclosure;

FIG. 4 is a schematic diagram showing an exemplary fusion of various Markov Chains that may be used in predicting event contribution completions, in accordance with an embodiment of the present disclosure;

FIG. 5 is a block diagram showing an exemplary overall workflow that may be used in determining semantically-similar prior-received event contributions, in accordance with an embodiment of the present disclosure;

FIG. 6 is a flow diagram showing an exemplary method for updating configuration parameters related to predicting event contribution completions from event contribution fragments, in accordance with an embodiment of the present disclosure;

FIG. 7 is a flow diagram showing an exemplary method for predicting event contribution completions from event contribution fragments, presenting prior-received event contributions that are semantically similar to predicted event contribution completions, and permitting a user to act upon prior-received, semantically-similar event contributions in lieu of completing and/or publishing his or her own contributions, in accordance with an embodiment of the present disclosure; and

FIG. 8 is a block diagram of an exemplary computing environment suitable for use in implementing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

“Event contribution” as used in the description below refers to completed and/or published text input (via typing input, speech input, or any other input modality) by a user of an event employing an interactive online Q&A tool.

“Event contribution fragment” refers to the text of an event contribution that has begun to be input by a user but has yet to be completed and/or published. Generally, completion of an event contribution fragment (which changes its status to an “event contribution” rather than an “event contribution fragment”) is signaled upon publication of the input text.

“Contribution identifier” refers to a unique identifier assigned to an event contribution or event contribution fragment that enables information with respect thereto to be identified, for instance, via a look-up table.

As previously set forth in the Background, large events, such as lectures, conferences, etc., are increasingly using interactive online question and answer (Q&A) tools to offer real-time feedback. For instance, there are a number of mobile, real-time Q&A tools in the marketplace that enable participants to ask questions, respond to questions (for instance, posed by the event coordinators or provided by other participants), or otherwise provide comments or feedback during an event, for instance, utilizing their mobile devices on mobile browsers. While offering much useful feedback, there can be instances in which the number of questions or other contributions becomes so numerous that the number of duplicate and/or highly-related contributions increases because users cannot keep up with them all. This results in a decrease in the overall quality of the contributions. Further, users may begin to overlook or otherwise miss content associated with the actual event because they are distracted by viewing and/or addressing the contributions provided by other participants and/or event coordinators.

Embodiments of the present disclosure are generally directed to systems and methods that aid users participating in events employing interactive online Q&A tools in meaningfully contributing to the Q&A with minimal loss of attention to the event. In this regard, embodiments of the present disclosure provide systems and methods that present to a user, while the user is inputting an event contribution fragment, similar event contributions (e.g., provided by other event participants) and permit the user to act upon the similar contributions in lieu of completing and/or publishing his or her own event contribution fragment. Input of an event contribution fragment is detected. While the event contribution fragment is being input (e.g., while the user is typing his or her event contribution but prior to completion and/or publication thereof), a probable event contribution completion for the user's event contribution fragment is predicted. Based upon the predicted event contribution completion, at least one semantically-similar, prior-received event contribution is provided to the user. Also provided is the ability for the user to act upon the prior-received event contribution in lieu of completing and/or publishing his or her own event contribution. For instance, the user may be provided the ability to vote on, comment on, or amend the semantically-similar, prior-received event contribution in lieu of completing and/or publishing his or her own contribution. Upon receiving an indication of a desired user action with respect to the semantically-similar, prior-received event contribution, the user-input event contribution fragment is discarded and the user's action on the prior-received event contribution is published in lieu thereof.

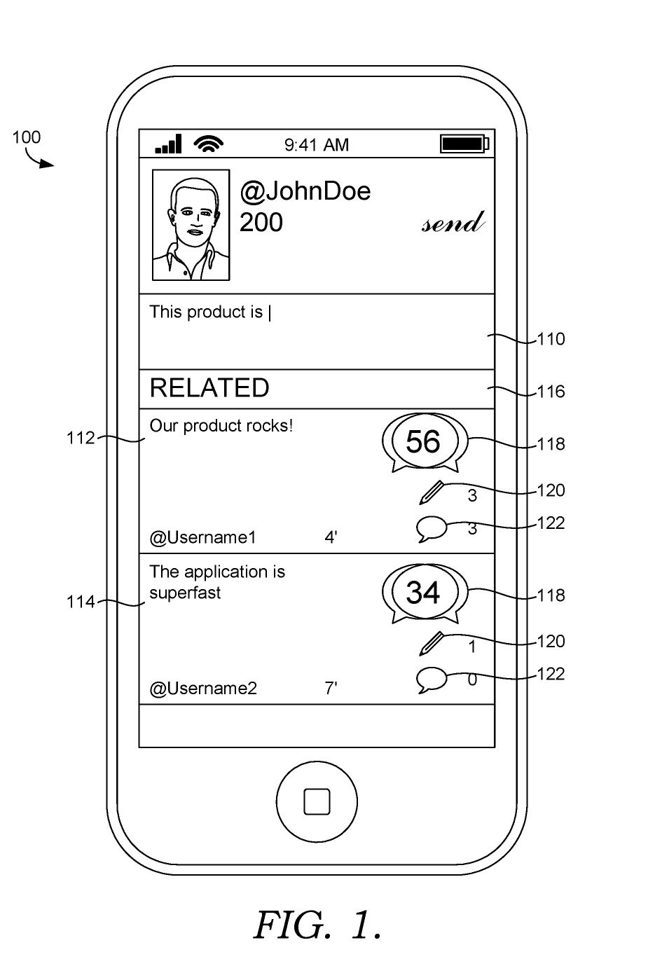

By way of example, and with reference to FIG. 1, a schematic diagram is illustrated showing an exemplary mobile device user interface 100 that may be used in conjunction with embodiments of the present disclosure. The user interface 100 shown in FIG. 1 is but one example of a possible user interface and is shown as an aid in describing the functionality of embodiments hereof. The illustrated user interface 100 is in no way intended to limit the scope of embodiments of the present disclosure. On his or her own initiative or in response to a question or comment posed to the event participants (e.g., by the event coordinators or presenters, or another event participant), the user of the mobile device user interface 100 begins to input an event contribution fragment into an event contribution input box 110. Such input may be by way of textual typing input, speech input, or any other available input modality. In the illustrated embodiment of FIG. 1, the event contribution fragment “This product is” has been input by the user into the event contribution input box 110. Input of the event contribution fragment is detected by the inventive system hereof. While the event contribution fragment is being input (e.g., while the user is typing his or her event contribution but prior to completion thereof, such completion being signaled by publication of the contribution fragment), a probable event contribution completion for the user's event contribution fragment is predicted. In accordance with an exemplary embodiment of the present disclosure, the predicted event contribution completion is not presented to the user. It will be understood and appreciated by those having ordinary skill in the relevant art, however, that embodiments of the present disclosure also contemplate presenting predicted event contribution completions to the user. Any and all such variations, and any combination thereof, are contemplated to be within the scope of embodiments hereof.

Based upon the predicted event contribution completion determined most probable (as more fully described below), at least one semantically-similar, prior-received event contribution is presented to the user. In the user interface 100 illustrated in FIG. 1, the semantically-similar, prior-received event contributions 112 (“Our product rocks!” published by Username1) and 114 (“The application is superfast” published by Username2) are illustrated as presented vertically beneath the heading “RELATED” 116. Also provided is the ability for the user to act upon each of the presented prior-received event contributions in lieu of completing and/or publishing his or her own event contribution. By way of example and not limitation, and as illustrated in connection with the user interface 100 of FIG. 1, the user is permitted to vote on 118, amend 120 or comment on 122 each presented semantically-similar, prior-received event contribution 112, 114. As illustrated, fifty-six participants have voted on related event contribution 112, three participants have amended this event contribution, and three participants have commented on this event contribution. Similarly, thirty-four participants have voted on related event contribution 114, one participant has amended this event contribution, and there have been zero comments on this event contribution. User selection of the voting indicator 118, amend indicator 120, or comment indicator 122 associated with a given semantically-similar, prior-received event contribution (e.g., 112 or 114) signals the desired user action.

Upon receiving an indication of a desired user action with respect to a semantically-similar, prior-received event contribution (112 or 114), the user-input event contribution fragment is discarded and the user's action on the prior-received event contribution (112 or 114) is published in lieu of the user-input event contribution fragment 110 or a completion thereof. For instance, user selection of a voting indicator 118 may result in the input event contribution fragment being discarded and the number of votes associated with the event contribution related to the selected voting indicator 118 being incremented upward by one unit. User selection of an amend indicator 120 may result in presentation of a user interface (not shown) that presents the text of the event contribution related to the selected amend indicator 120 and permits amending thereof followed by publication. In this instance, the amended contribution may be displayed as a separate event contribution to later users, or as a sub-contribution to the associated contribution. User selection of a comment indicator 122 may cause presentation of a user interface (not shown) that permits the user to input a comment related to the event contribution associated with the selected comment indicator 122 and publish the same. Again, this comment may be presented as a separate contribution to later users, or as a sub-contribution to the associated event contribution.

Accordingly, one embodiment of the present disclosure is directed to a method for aiding event participants in meaningfully contributing to event online Q&A with minimal loss of attention to the event. The method includes providing configuration parameters for a crowd consensus tool to a plurality of devices, the configuration parameters including an event contribution prediction model derived from at least one of general language reference material, event-specific material, prior-received event contributions, or a combination thereof. The method further includes receiving a discarded event contribution fragment and a contribution identifier associated with a prior-received event contribution acted upon in lieu of publishing the discarded event contribution fragment, updating the configuration parameters utilizing the discarded event contribution fragment and the contribution identifier associated with the prior-received event contribution that was acted upon lieu of publishing the discarded event contribution fragment, and providing the updated configuration parameters to the plurality of devices.

In another embodiment, the present disclosure is directed to another method for aiding event participants in meaningfully contributing to event online Q&A with minimal loss of attention to the event. The method includes detecting user input of an event contribution fragment, predicting at least one probable event contribution completion from the event contribution fragment, determining at least one prior-received event contribution that is semantically-similar to the at least one probable event contribution completion, presenting the at least one semantically-similar prior-received event contribution, and providing an ability for a user to act upon the at least one semantically-similar prior-received event contribution.

In yet another embodiment, the present disclosure is directed to a computerized system for aiding event participants in meaningfully contributing to event online Q&A with minimal loss of attention to the event. The system includes a processor and a computer storage medium storing computer-useable instructions that, when used by the processor, cause the processor to: provide configuration parameters to a plurality of devices, detect user input of an event contribution fragment, predict at least one probable event contribution completion from the event contribution fragment, determine at least one prior-received event contribution that is semantically-similar to the at least one probable event contribution completion, provide the at least one semantically-similar prior-received event contribution and an ability for a user to act upon the at least one semantically-similar prior-received event contribution, receive a user action with respect to the at least one semantically-similar prior-received event contribution, and discard the event contribution fragment.

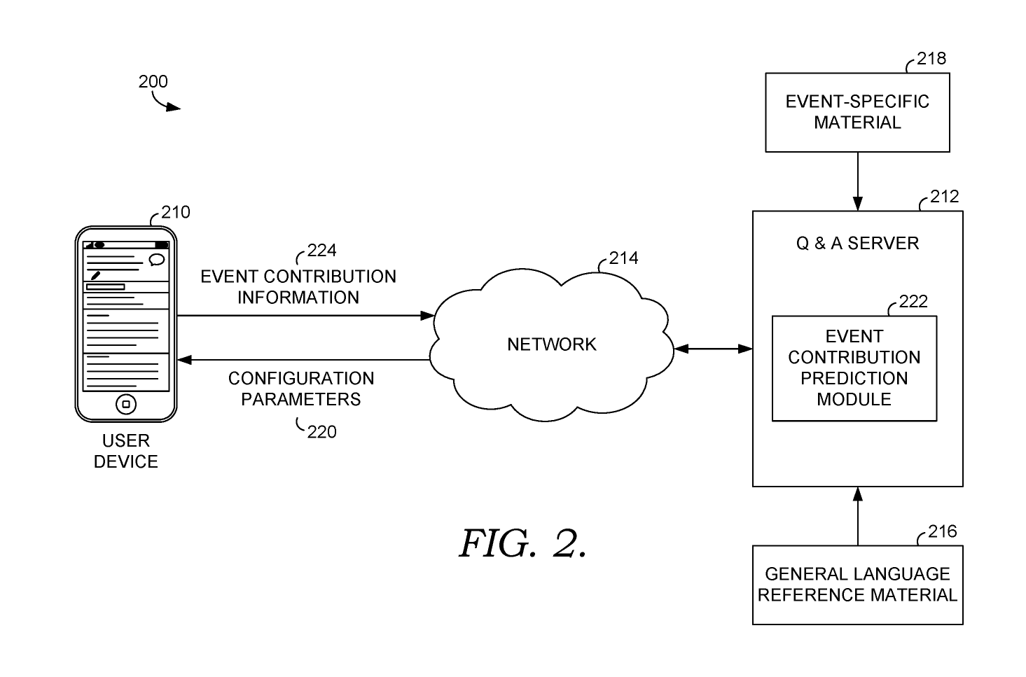

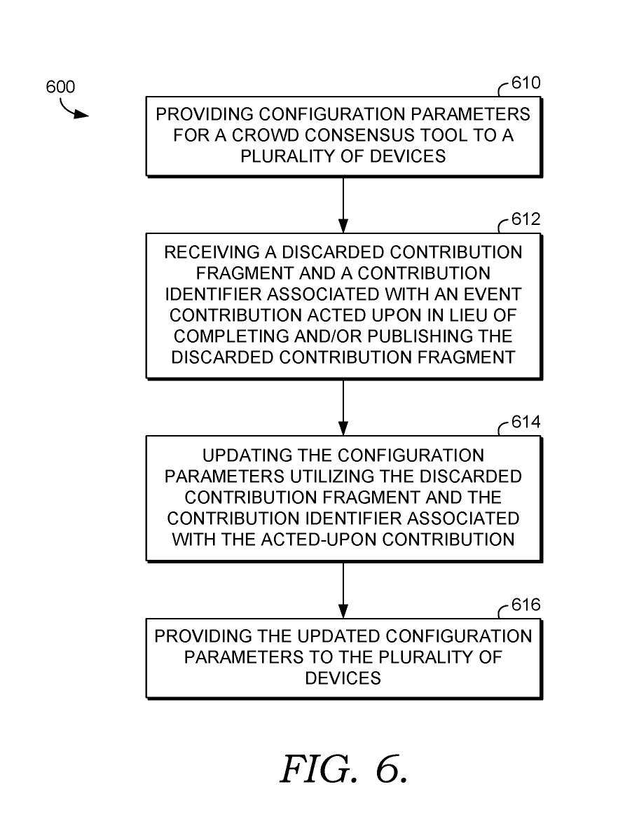

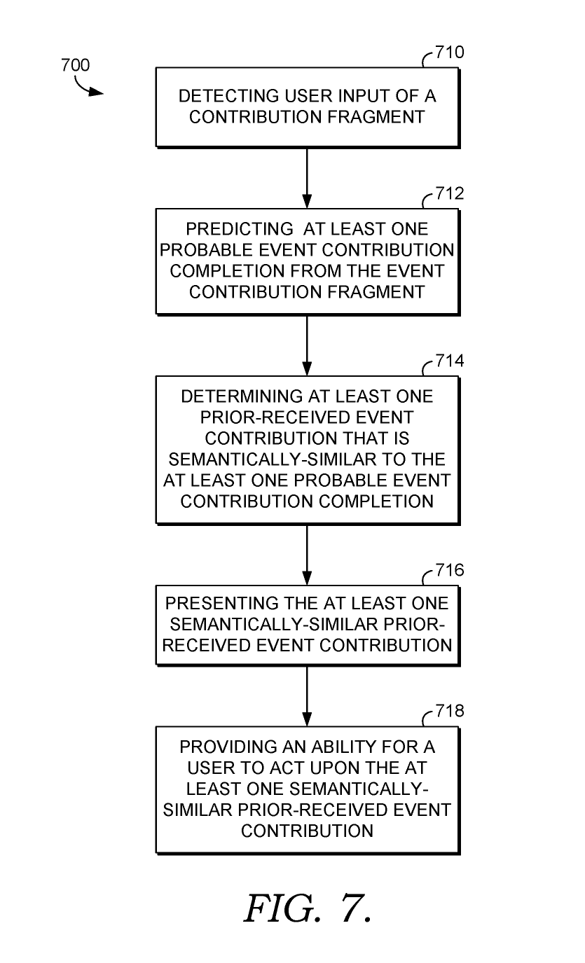

Referring now to FIG. 2, a block diagram is provided that illustrates a crowd consensus system 200 for aiding event participants in meaningfully contributing to an online event Q&A with minimal loss of attention to the event, in accordance with an exemplary embodiment of the present disclosure. Generally, the system 200 illustrates an environment in which participants may be aided in contributing to online Q&A sessions in accordance with the methods, for instance, illustrated in FIGS. 6 and 7 (more fully described below). Among other components not shown, the crowd consensus system 200 includes at least one user device 210 (illustrated in FIG. 2 as a single mobile device), the user device 210 and a Q&A server 212. The user device 210 and the Q&A server 212 are in communication with one another through a network 214. The network 214 may include, without limitation, one or more local area networks (LANs) and/or wide area networks (WANs). Such networking environments are commonplace in offices, enterprise-wide computer networks, intranets, and the Internet and, accordingly, the network 214 is not further described herein. It should be understood that any number of user devices 210 and Q&A servers 212 may be employed by the crowd consensus system 200 within the scope of embodiments of the present disclosure. Each may comprise a single device or multiple devices cooperating in a distributed environment. Additionally, other components not shown may also be included within the network environment.

In some embodiments, one or more of the illustrated components/modules may be implemented as stand-alone applications. In other embodiments, one or more of the illustrated components/modules may be implemented via a server or as an Internet-based service. It will be understood by those having ordinary skill in the art that the components/modules illustrated in FIG. 2 are exemplary in nature and in number and should not be construed as limiting. Any number of components/modules may be employed to achieve the desired functionality within the scope of embodiments hereof.

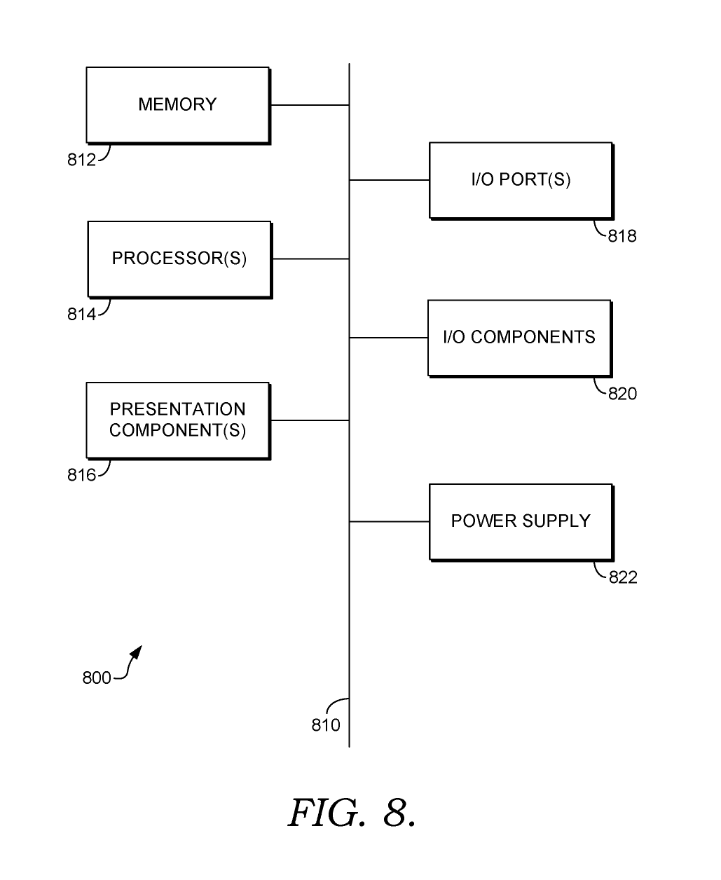

It should be understood that the crowd consensus system 200 generally operates to aid users in meaningfully contributing to an online Q&A session during an event with minimal loss of attention to the event. It should be further understood that the crowd consensus system 200 shown in FIG. 2 is an example of one suitable computing system architecture. The illustrated arrangement, and other arrangements described herein, are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. Each of the components shown in FIG. 2 may be implemented via any type of computing device, such as computing device 800 described with reference to FIG. 8, for example.

With continued reference to FIG. 2, and in accordance with embodiments of the present disclosure, when an event employing an online interactive Q&A system is getting ready to take place, information related to the event may be provided to the Q&A server 212 which hosts the backend of the crowd consensus system 200. Such information may include, without limitation, one or more of general language reference material 216 and event-specific material 218. The Q&A server 212 generally is configured to enjoy primary responsibility for computationally intensive tasks and common computations that need to be performed. One or more user devices 210 connect to the Q&A server 214 (generally by requesting a webpage via the network 214). In response, the Q&A server 214 provides to the requesting user device(s) 210 configuration parameters 220 that include an event contribution prediction model 222. The event contribution prediction model 222 is derived from at least one of the information related to the event (e.g., the general language reference material 216 and/or the event-specific material 218) and any prior contribution information received 224 (e.g., from other participants) during the event. By way of example, the prior-received contribution information 224 may include, without limitation, prior-received event contributions, discarded event contribution fragments, actions taken by users with respect to prior-received event contributions (including contribution identifiers associated with the acted upon prior-received event contributions), any information derived from such event contribution information, or any combination thereof. Generally, at the beginning of the event, there will not be any prior-received contribution information to provide. Also provided are any additional configuration parameters 220 needed to run the algorithms in the frontend (i.e., on the user device 210). Configuration parameters may include, by way of example only, a preference for more prominently presenting most-voted-on contributions or most-recent contribution. For instance, if a user has not input any text, or if the search for semantically-similar prior-received contributions turns up empty, the user may be presented with a list of most-voted-on contributions or most-recent contributions in accordance with the associated configuration preference, provided such information is available.

Once an event participant inputs text into an event contribution input box (e.g., box 110 of FIG. 1), the user device 210 may use the methods more fully described below to provide a set of semantically-similar, prior-received event contributions. In embodiments, every event contribution input by a participant is communicated to the Q&A server 214. Additionally, the Q&A server 214 receives the information about any discarded contribution fragments and a contribution identifier associated with any prior-received event contributions acted upon in lieu of publishing a discarded event contribution fragment. By processing all of this information, the Q&A server is able to forward incremental updates to the list of event contributions to the user device 210, as well as updated configuration parameters, as needed.

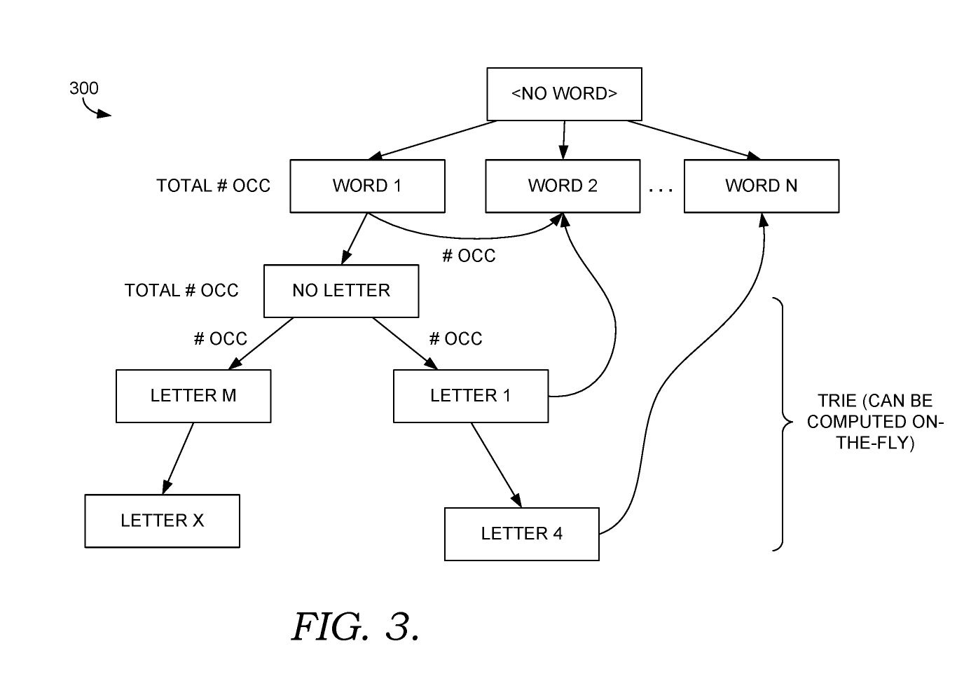

Once an event participant inputs text into an event contribution input box (e.g., box 110 of FIG. 1), the user device 210 may utilize word prediction to guide the related contributions search. There are many possible methods that may be utilized for word prediction, as known to those having ordinary skill in the relevant art. In accordance with embodiments of the present disclosure, a type of hierarchical Markov chain approach may be used in which the first level of the Markov chain represents words (or a fixed-length sequences of words), while the second level represents letters. The second level (inside each word) may be built on-the-fly by considering all successor words or current words (or sequence of words) and may employ a trie data structure so that prefixes among successors are shared. In other words, a trie data structure permits encoding the prefixes of the possible continuations to the current word. Any exemplary trie data structure 300 is illustrated in the schematic diagram of FIG. 3.

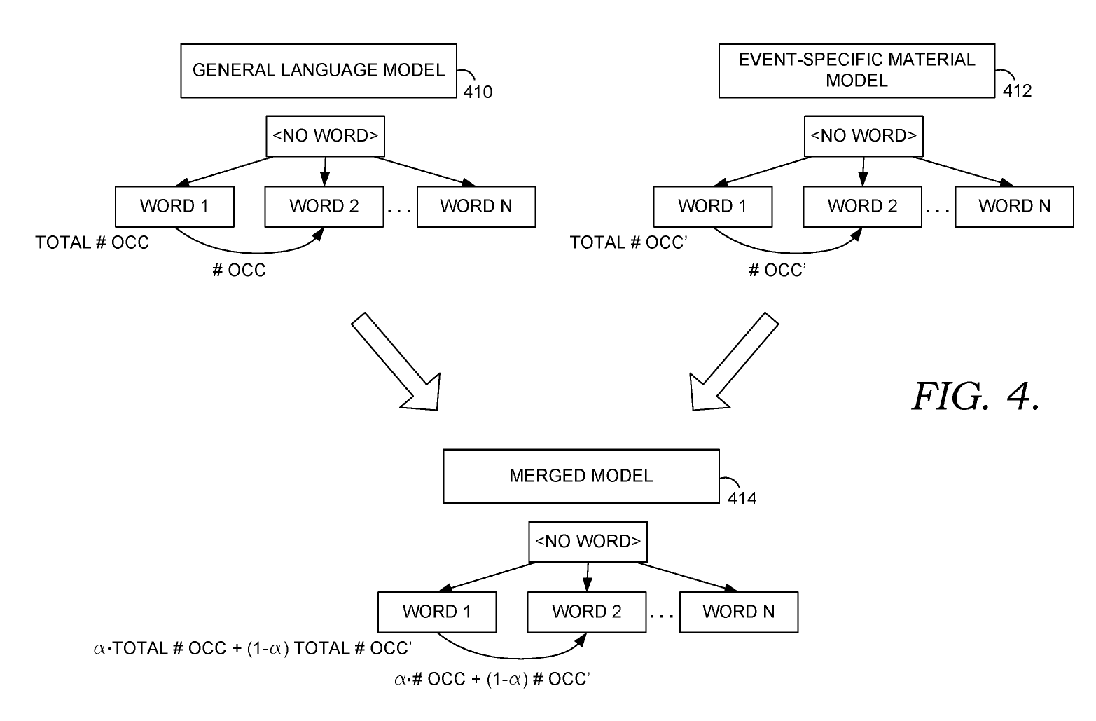

Keeping the number of occurrences in the nodes/edges, rather than the probabilities, enables the merging of different models, as shown in FIG. 4. As illustrated, a general language reference model 410, an event-specific material model 412 and a merged model 414 are illustrated. Note that since the trie structures can be computed on the fly and for readability purposes, only the first level of the hierarchical Markov models is shown. Further note that while not illustrated in FIG. 4, a model for prior-received event contributions may also be provided and merged with the general language reference model 410 and the event-specific material model 412 to arrive at the merged model 414. Any and all such variations, and any combination thereof, are contemplated to be within the scope of embodiments of the present disclosure. As illustrated in FIG. 4, an alpha factor is used to weight the different models.

In accordance with embodiments of the present disclosure, computed models (e.g., hierarchical Markov models) are used by the user device (e.g., user device 210 of FIG. 2) to predict the words being input by a user as an event contribution (or contribution fragment), resulting in return of a plurality of possible event contribution completions (e.g., words) and their probabilities. (It should be noted that this list of possible event contribution completions may or may not be presented to the user, in accordance with various embodiments of the present disclosure.) Though used by the user device, however, the models are provided and updated by the Q&A server (e.g., Q&A server 214 of FIG. 2).

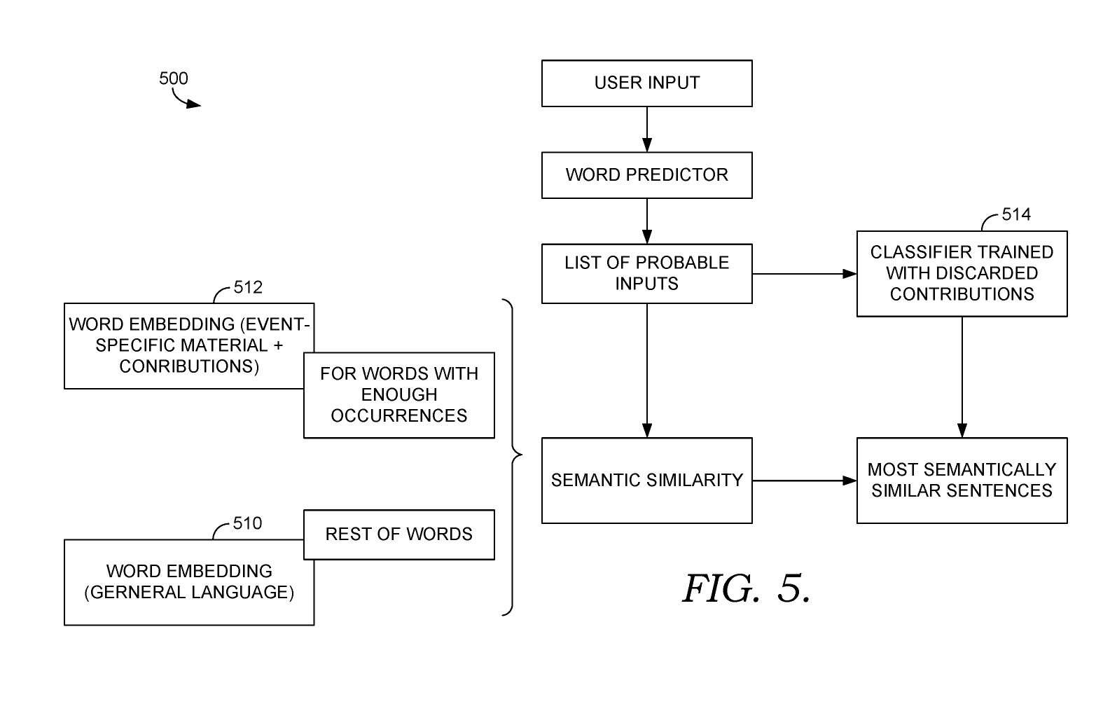

Turning now to FIG. 5, FIG. 5 a block diagram is illustrated showing an exemplary overall workflow 500 that may be used in determining semantically-similar prior-received event contributions, in accordance with embodiments of the present disclosure. Given any already completed words comprising an event contribution fragment, and the list of predicted event contribution completions, the user device determines the most semantically-similar prior-received event contribution(s). In embodiments of the present disclosure, two recommendation modules may be combined for making such determination. In a first technique, the similarity between two strings of words may be computed. For each word in the longest string, the most similar word in the other string (comparing word embedding vectors) may be computed. Subsequently, all computed similarities may be summed. In embodiments, a system in accordance with the present disclosure has two word strings to compare: one coming from the general language reference model 510 and the other based on the event-specific material and prior-received event contributions 512. The user device may use one or the other embedding, depending on whether the compared words appear frequently enough in the event-specific material and prior-received event contributions, or not. For pairs of words in which one word appears frequently enough and the other does not, the general language reference embedding will be used.

The second technique is a machine learning technique. This technique is built using discarded event contribution fragments. As an example of a possible classifier 514 of such task, a K-nearest neighbors approach may be used, using the string amend distance between the list of probable contribution completions and previously discarded event contribution fragments. The outcome of this classifier is a list of candidate prior-received contributions with an associated probability.

To create a sorted list of semantically-similar prior-received contributions, each contribution in the list of probable contribution completions includes an associated probability. If the event contribution fragment consists of whole, completed words, the probability is equal to one and the list will contain a single entry. Each entry will go through both recommendation modules (similarity of word strings and machine learning classifier) and this will yield two lists of candidate semantically-similar prior-received contributions with associated distances/probabilities. (Note if it is a distance, it can be converted into a probability mapping probability 1.0 to distance 0 and probability 0.0 to values over a defined distance threshold, doing a uniform distribution in the range, or by using some exponential function like e to the power of −distance.). The final probability of each combination of entry in the list and candidate semantically-similar prior-received contribution will be obtained by multiplying the probability of the entry with the probability of the candidate.

In accordance with embodiments of the present disclosure, the Q&A server (e.g., Q&A server 214 of FIG. 2) is responsible for re-computing the word embeddings when enough new contributions have been sent to the server. The Q&A server then provides the result to the user devices (e.g., user device 210 of FIG. 2).

When a user decides to discard an event contribution fragment in favor of acting upon (e.g., voting on, commenting on, amending, etc.) a prior-received contribution, the user device provides, to the Q&A server, the discarded text plus a contribution identifier associated with the acted upon contribution. The Q&A server trains a supervised classifier (for instance, a K-nearest neighbor classifier) and updates all user devices when the classifier has reached a threshold number of discarded event contribution fragments received.

The Q&A server also updates the word predictor based upon the other prior-received event contributions and the event-specific material. In this regard, if the event-specific material is sequentially presented to the event participants (e.g., in a large event in which people participating have not been exposed to the material before), the Q&A server may take into account that participants are more likely to ask questions about topics when the topics are being presented to them. To do so, the Q&A server may try to locate the current location of the “speech” by considering the word distribution of the received contributions within a given, recent time frame, and then modify the word predictor by considering the information presented thus far, possibly giving extra weight to later-introduced concepts.

Turning now to FIG. 6, a flow diagram is provided that illustrates a method 600 that aids users participating in events employing interactive online Q&A tools in meaningfully contributing to the Q&A with minimal loss of attention to the event, in accordance with embodiments of the present disclosure. In embodiments, the method 600 may be employed utilizing the crowd consensus system 200 of FIG. 2 and, more particularly, may include functions performed by the backend Q&A server thereof. As shown at step 610, configuration parameters for a crowd consensus tool are provided to a plurality of user devices. The configuration parameters may include an event contribution prediction model derived from, without limitation, at least one of general language reference material, event-specific material, prior-received event contributions, or a combination thereof. As shown at step 612, received are a discarded event contribution fragment and a contribution identifier associated with a prior-received event contribution acted upon in lieu of completing and/or publishing the discarded event contribution fragment. As shown at step 614, the configuration parameters are updated using the discarded event contribution fragment and the contribution identifier associated with the prior-received event contribution that was acted upon lieu of completing and/or publishing the discarded event contribution fragment. As shown at step 616, the updated configuration parameters are provided to the plurality of devices.

With reference to FIG. 7, a flow diagram is provided that illustrates a method 700 that aids users in participating in events employing interactive online Q&A tools in meaningfully contributing to the Q&A with minimal loss of attention to the event, in accordance with embodiments of the present disclosure. In embodiments, the method 700 may be employed utilizing the crowd consensus system 200 of FIG. 2 and, more particularly, may include functions performed by the device frontend 212 of the user device 210. As shown at step 710, user input of an event contribution fragment is detected. As shown at step 712, at least one probable event contribution completion is predicted from the event contribution fragment. As shown at step 714, at least one prior-received event contribution is determined that is semantically-similar to the at least one probable event contribution completion. As shown at step 716, the at least one semantically-similar prior-received event contribution is presented. An ability for a user to act upon the at least one semantically-similar prior-received event contribution is provided, as shown at step 718.

Having described embodiments of the present disclosure, an exemplary operating environment in which embodiments of the present disclosure may be implemented is described below in order to provide a general context for various aspects of the present disclosure. Referring to FIG. 8 in particular, an exemplary operating environment for implementing embodiments of the present disclosure is shown and designated generally as computing device 800. Computing device 800 is but one example of a suitable computing environment and is not intended to suggest any limitation as to the scope of use or functionality of the inventive embodiments. Neither should the computing device 800 be interpreted as having any dependency or requirement relating to any one or combination of components illustrated.

The inventive embodiments may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With continued reference to FIG. 8, the computing device 800 includes a bus 810 that directly or indirectly couples the following devices: a memory 812, one or more processors 814, one or more presentation components 816, one or more input/output (I/O) ports 818, one or more input/output (I/O) components 820, and an illustrative power supply 822. The bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 8 and reference to “computing device.”

The computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer-storage media in the form of volatile and/or nonvolatile memory. The memory may be removable, non-removable, or a combination thereof. Exemplary hardware devices include solid-state memory, hard drives, optical-disc drives, etc. The computing device 800 includes one or more processors that read data from various entities such as the memory 812 or I/O components 820. The presentation component(s) 816 present data indications to a user or other device. Exemplary presentation components include a display device, speaker, printing component, vibrating component, etc.

The I/O ports 818 allow the computing device 800 to be logically coupled to other devices including the I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

As can be understood, embodiments of the present disclosure provide for aiding event participants in meaningfully contributing to event online Q&A with minimal loss of attention to the event. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. A method comprising:
providing configuration parameters for a crowd consensus tool to a plurality of devices, the configuration parameters including an event contribution prediction model derived from at least one of general language reference material, event-specific material, prior-received event contributions, or a combination thereof;
receiving a discarded event contribution fragment and a contribution identifier associated with a prior-received event contribution acted upon in lieu of publishing the discarded event contribution fragment;
updating the configuration parameters utilizing the discarded event contribution fragment and the contribution identifier associated with the prior-received event contribution that was acted upon lieu of publishing the discarded event contribution fragment; and
providing the updated configuration parameters to the plurality of devices.

2. The method of claim 1, further comprising providing a plurality of prior-received event contributions to the plurality of devices.

3. The method of claim 1, wherein the event contribution prediction model uses at least one hierarchical Markov chain.

4. The method of claim 1, wherein updating the configuration parameters comprises updating the configuration parameters by training a supervised classifier.

5. The method of claim 4, wherein updating the configuration parameters by training the supervised classifier comprises updating the configuration parameters by training a K-Nearest Neighbor supervised classifier.

6. The method of claim 1,
wherein receiving the discarded event contribution fragment and the contribution identifier associated with the event contribution acted upon in lieu of publishing the discarded event contribution fragment comprises receiving a plurality of discarded event contribution fragments each having an associated event contribution that was acted upon in lieu of publishing the respective discarded event contribution fragment,
and wherein updating the configuration parameters comprises incrementally updating the configuration parameters when a threshold number of discarded event contribution fragments has been received.

7. A method comprising:
detecting user input of an event contribution fragment;
predicting at least one probable event contribution completion from the event contribution fragment;
determining at least one prior-received event contribution that is semantically-similar to the at least one probable event contribution completion;
presenting the at least one semantically-similar prior-received event contribution; and
providing an ability for a user to act upon the at least one semantically-similar prior-received event contribution.

8. The method of claim 7, wherein detecting user input of the event contribution fragment comprises detecting user input of the event contribution fragment in response to presentation of information related to an event for which a crowd consensus tool is being used.

9. The method of claim 7, wherein providing the ability for the user to act upon the at least one semantically-similar prior-received event contribution comprises providing the ability for the user to at least one of vote on, comment on, or amend the at least one semantically-similar prior-received event contribution in lieu of publishing the event contribution fragment.

10. The method of claim 7, wherein at least one hierarchical Markov chain is used to predict the at least one probable event contribution completion from the event contribution fragment.

11. The method of claim 7, further comprising:
receiving a user action with respect to the at least one semantically-similar prior-received event contribution; and
discarding the event contribution fragment.

12. The method of claim 7, wherein predicting the at least one probable event contribution completion from the event contribution fragment comprises predicting the at least one probable event contribution completion utilizing one or more of general language reference material, event-specific material, prior-received event contributions, or a combination thereof.

13. The method of claim 12, wherein predicting the at least one probable event contribution completion from the event contribution fragment comprises predicting the at least one probable event contribution completion utilizing event-specific material and a location within the event-specific material.

14. The method of claim 7, wherein the at least one probable event contribution completion includes at least one completed word included in the event contribution fragment and at least one predicted word.

15. A computerized system comprising:
a processor; and
a computer storage medium storing computer-useable instructions that, when used by the processor, cause the processor to:
provide configuration parameters to a plurality of devices;
detect user input of an event contribution fragment;
predict at least one probable event contribution completion from the event contribution fragment;
determine at least one prior-received event contribution that is semantically-similar to the at least one probable event contribution completion;
provide the at least one semantically-similar prior-received event contribution and an ability for a user to act upon the at least one semantically-similar prior-received event contribution;
receive a user action with respect to the at least one semantically-similar prior-received event contribution; and
discard the event contribution fragment.

16. The system of claim 15, wherein the computer-useable instructions, when used by the processor, further cause the processor to update the configuration parameters using the discarded event contribution fragment and a contribution identifier associated with the at least one semantically-similar prior-received event contribution.

17. The system of claim 16, wherein the computer-useable instructions, when used by the processor, further cause the processor to provide the updated configuration parameters to the plurality of devices.

18. The system of claim 15, wherein the at least one probable event contribution completion is predicted, at least in part, utilizing general language reference material, event-specific material, prior-received event contributions, or a combination thereof.

19. The system of claim 18, wherein the at least one probable event contribution completion is predicted from the event contribution fragment utilizing event-specific material and a location within the event-specific material.

20. The system of claim 15, wherein at least one hierarchical Markov chain is used to predict the at least one probable event contribution completion from the event contribution fragment.
